(19) United States
(12) Patent Application Publication
(10) Pub. No.: US 2008/0044579 A1
(43) Pub. Date: Feb. 21, 2008

(54) Labelling System

(76) Inventor: Matthew Sean Price, Barnsley (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/720,152

(22) PCT Filed: Nov. 7, 2005
(86) PCT No.: PCT/GB05/04288

§ 371 Date: Aug. 2, 2007

(30) Foreign Application Priority Data
Nov. 26, 2004 (GB) 0425933.9

(51) Int. Cl. B32B 3/10; B32B 27/38

(52) U.S. Cl. 427/386; 427/2.1; 427/314; 427/372.2

(57) ABSTRACT

A method of labelling an instrument comprising the steps of: providing a recess in a surface of the instrument, the recess having a lowermost surface and an uppermost aperature, the lowermost surface having a larger surface area than the area of said uppermost aperatuer; placing a coloured liquid resin into said recess; heating the instrument in order to cure said resin, whereby a coloured resin label is formed in said recess.

This invention relates to the field of labelling medical instruments, in particular those for use in sterile surgical conditions.

Surgical instruments may be colour-coded with a label in order to visually indicate their size, purpose, left or right-handedness or other characteristics. A non-exhaustive list of instruments having such labelling includes: hip, knee, toe, spinal, shoulder, elbow and tibial instruments, femoral reamers, rasps, graters and cutting blocks.

The colour-coded labels generally comprise one or more regions of colour, whose meaning is determined with reference to a key.

Such colour-coded labels must be:
1. non-toxic, as the instrument is obviously intended to be used in a sterile environment;
2. permanently fixed to the instrument as it is clearly very undesirable for the label to become detached and fall into the operating area;
3. durable so that there is substantially no colour fading or corrosion over time;
4. substantially unaffected by sterilisation processes, autoclaves, ultrasound treatment, heat treatment etc.

A known method of colour-coded labelling for surgical instruments comprises using one or more coloured plastic rings, plugs, press-pins or tags. Such labels are physically attached to the surgical instruments and occasionally suffer the problem of becoming undesirably detached from the instruments, not only creating a medical risk to the patient but also meaning the unlabelled instrument can not be sterilised and used again.

Furthermore, it is not always possible to conveniently attach such a label to some instruments. Those instruments which are particularly small or thin may not comprise enough material to which a label could be attached.

It is labour-intensive and therefore expensive to attach physical colour-coded labels to each surgical instrument.

Finally, it is undesirable to have the colour-coded label physically protruding from (i.e. not flush with) the surface of the instrument, creating a risk that the label may be broken off.

As an alternative to a physically-attached label, it is known to create a depression or recess at a convenient location on the instrument and then fill this recess with a coloured epoxy resin which, when cured, forms a solid coloured label within the recess. Such a process is described in French patent number FR2760630 [Chapelle et al].

However, any epoxy resin to be used in a surgical environment must be subjected to rigorous tests as to its non-toxicity. Furthermore, there is a significant risk that, during heat treatment in an autoclave for example, the epoxy resin label may expand at a different rate to the instrument and become loosened or detached from the recess in which it is located. The label may then fall off the instrument in the autoclave or, even more undesirably, during a surgical procedure.

Consequently, the choice of resin for use in such a procedure is critical, in order to ensure the resin has suitable properties. FR2760630 simply indicates that the resin used therein is a thermosetting resin, for example “a powdered epoxy resin”.

As it is desirable to have the label flush with the surface of the instrument, an additional method step is required in the process of FR2760630 in order to polish off or otherwise remove any surplus resin left protruding from the recess.

It is an object of the present invention to provide apparatus and a method for colour-coding instruments which seeks to alleviate the above-described problems.

According to a first aspect of the present invention there is provided a method of labelling an instrument comprising the steps of:
providing a recess in a surface of the instrument, the recess having a lowermost surface and an uppermost aperture, the lowermost surface having a larger surface area than the area of said uppermost aperture;
applying a coloured liquid resin into said recess;
heating the instrument in order to cure said resin,
   whereby a coloured resin label is formed in said recess.

Preferably, the walls of said recess taper inwardly from said lowermost surface to said uppermost aperture.

Preferably, said recess has a roughened or other friction-increasing wall in order to improve the grip between the resin and the instrument.

In a preferred form, said recess is of substantially circular cross-section.

In a preferred form, said lowermost surface of the recess is generally conical so as to accommodate more resin and improve grip between the resin and the instrument.

Preferably, said recess is provided with a parallel-walled section at the uppermost surface thereof.

Preferably, the method further comprises the step of preheating the instrument before applying the resin so as to improve the conditions for curing of the resin.

Preferably, said resin is applied to the recess using metering apparatus so that the dose of resin can be carefully regulated.

Preferably, the recess is filled with resin until a substantially concave meniscus is present at the uppermost aperture of the recess. The top surface of the resin is preferably concave so that no part of the finished resin label protrudes above the surface of the instrument.

Preferably, said resin is a two-part liquid resin which is mixed before placing it in the recess. Ideally, the resin is mixed in said metering apparatus.

The resin is preferably an epoxy resin selected from the group comprising: Master Bond EP42HT-2, Resin Tech RT156.

In one embodiment, said resin is cured for 24 hours at room temperature.

In an alternative embodiment, the resin is cured for 30 minutes at 75° C.

In a further alternative embodiment, the resin is cured for 5 minutes at 100° C.

In yet a further embodiment, the resin is cured for 24 hours at room temperature and then 2 hours at 75° C.

In a preferred form, two or more recesses are provided on the instrument.

Preferably, the instrument is a surgical instrument.

According to a second aspect of the invention there is provided an instrument labelled using the method of any of the preceding paragraphs.

The coloured resin provides a clear and durable colour-coded label for the surgical instrument which can withstand the repeated sterilisation and/or heat treatment processes to which a surgical instrument is typically subjected.

Preferred embodiments of the present invention will now be more particularly described by way of example only, with reference to the accompanying drawings wherein:

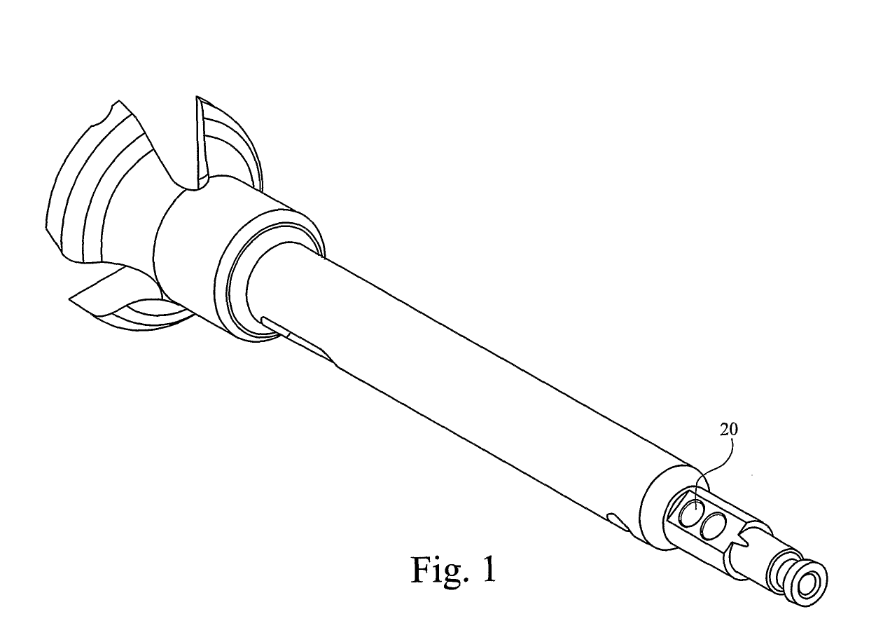

FIG. 1 shows a chamfer cutter including a colour-coded label;

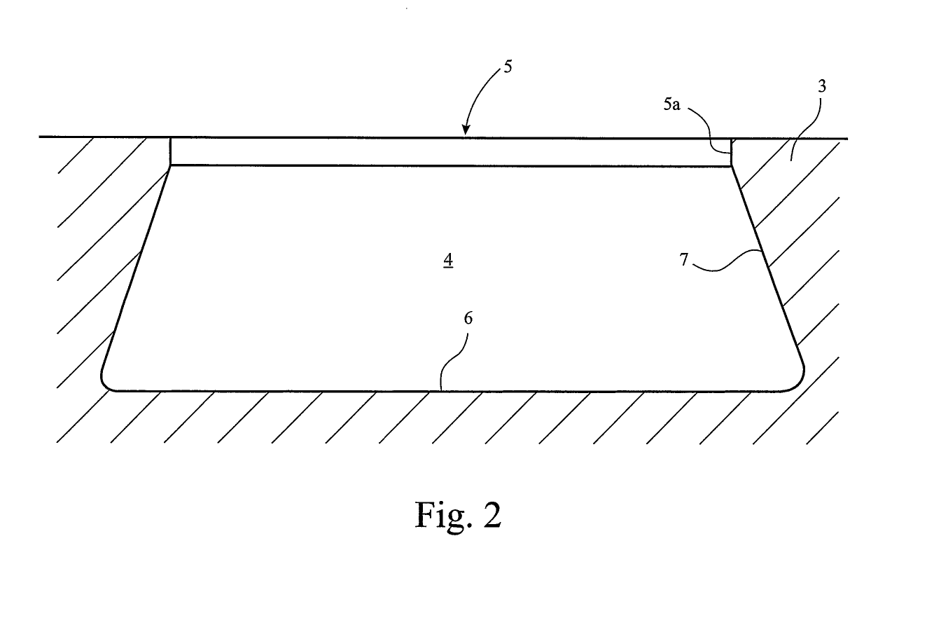

FIG. 2 is a schematic cross-sectional view of a recess in a surgical instrument for use in the present invention;

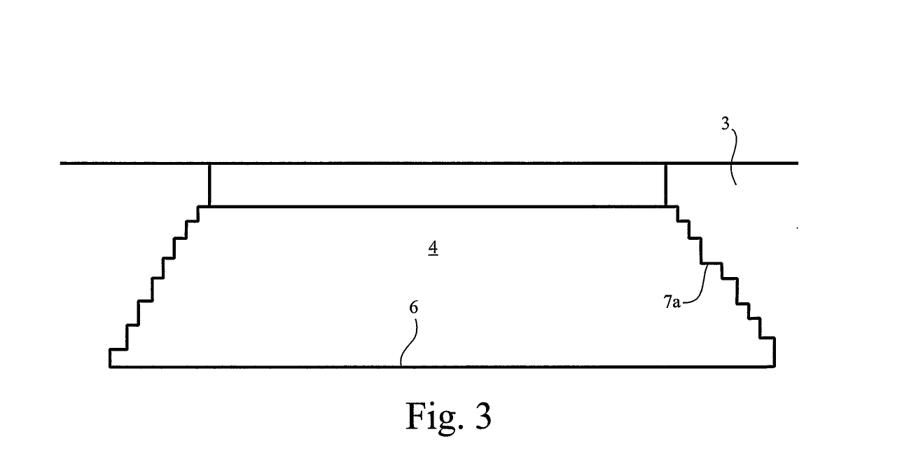

FIG. 3 is a schematic cross-sectional view of an alternative embodiment of the recess; and

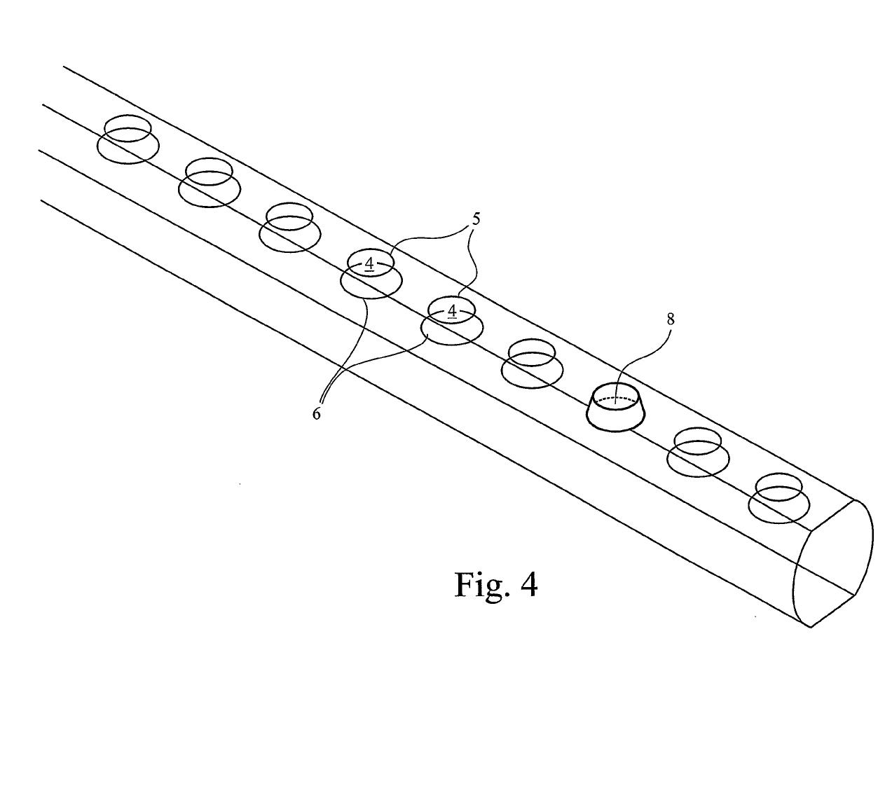

FIG. 4 is a schematic perspective view of a section of a surgical instrument, showing a plurality of recesses and one label in place.

Throughout this description, reference to the term “disc” is not limited to meaning a strictly circular disc.

FIG. 1 shows a chamfer cutter which includes a colour-coded label 20.

The colour coded label 20 is coloured according to a standard key to give a predefined meaning thereto and, optionally, may be provided with text and/or numerals thereon.

Referring to FIG. 2, a surgical instrument 3 is provided with one or more recesses 4 of a suitable size for creating a colour coded label. The recesses 4 may be created by using a pre-formed drill sink to the desired depth then, using an oscillating specific angle dovetail cutter, enlarging the recess to the desired diameter. The recess 4 has an uppermost aperture 5 and a lowermost surface 6. The lowermost surface 6 has a larger surface area than the area of the uppermost aperture 5, so that the recess 4 has undercut or tapered walls as illustrated in FIG. 2.

Preferably, the recess 4 has a parallel-walled section 5a near the uppermost surface 5 thereof. Below that, the side walls 7 of the recess are tapered outwardly from the uppermost aperture 5 down to the lowermost surface 6.

A two-part liquid resin is used in order to form the coloured label. The resin needs to be resistant to medical sterilisation, whether by radiation, chemicals or steam/heat such that the risk of the label becoming detached from the surgical instrument is minimised. Toxicity certification may be required before the resin can be used in a medical environment.

The resin is preferably a two-part heat substantially heat resistant epoxy adhesive, sealant, coating and casting resin. Two examples of suitable resins are given below.

### RESIN EXAMPLE 1

### Master Bond EP42HT-2

This is a room temperature curable polymer resin which does not require pre-heating.

### RESIN EXAMPLE 2

### Resin Tech RT156

This is a medium temperature curing epoxy adhesive for which pre-heating is appropriate (see further detail below).

Metering apparatus of known type can be used to mix the resin to the required ratio of the two-part formulation and then to supply to resin to the recess 4 in the required dose. Use of the metering apparatus is advantageous to avoid wastage of resin and to ensure the recess is filled as accurately as possible, without air bubbles and without excess resin protruding from the recess. Any excess resin protruding from the recess would usually have to be polished or otherwise removed, undesirably adding another step to the method. The use of a liquid resin in the present invention means that the resin can be mixed and metered more easily compared with the powdered resin used in the known prior art.

Preferably, the surgical instrument can be preheated before applying the resin to the recess so that when the resin is applied to the recess, the surgical instrument is already at or near the nominal curing temperature. This gives a more consistent curing temperature for the resin. Without pre-heating, whilst the resin might reach the curing temperature relatively quickly, it takes a much longer period for the surgical instrument to reach the desired curing temperature, creating an imbalance in their respective temperature profiles.

In order to apply a label to the surgical instrument 3, the following method steps are used, depending upon the epoxy resin selected.

### RESIN EXAMPLE 1

### Master Bond EP42HT-2

The surgical instrument having a recess therein is ultrasonically cleaned before applying the resin. The two parts of the resin are mixed 100:40 by weight or 100:50 by volume (the curing agent in the smaller quantity).

Next the mixed liquid resin is drawn into a syringe or other metering system from which the required dosage can be applied to the recess until a concave meniscus is present at the upper surface of the recess.

The resin is then left to cure at room temperature for 24 hours, then cured for a further two hours at 75° C.

Other curing regimes may be envisaged, for example 24 hours at 25° C. instead of 2 hours at 75° C.

### RESIN EXAMPLE 2

### Resin Tech RT156

The surgical instrument having a recess therein is ultrasonically cleaned before applying the resin. Next the instrument is preheated for 30 minutes at 75° C.

The two parts of the resin are slowly mixed in the ratio 100:25 (the curing agent in the smaller quantity). Slow mixing is preferable to avoid trapping air bubbles in the mixture.

Next the mixed liquid resin is drawn into a syringe or other metering system from which the required dosage can be applied to the recess until a concave meniscus is present at the upper surface of the recess.

The resin is then left to cure for a thirty minutes at 75° C.

Other curing regimes may be envisaged, for example 24 hours at 25° C. or 5 minutes at 100° C., instead of 30 minutes at 75° C.

The parallel-walled section 5a may assist in ensuring that a suitable does of resin is applied to the recess. The metering apparatus may be set to apply a dose of resin within preset maximum and minimum limits. The top and bottom limits of the parallel-walled section 5a may be used to indicate the maximum and minimum “fill” levels, with a nominal “target” fill level intermediate the maximum and minimum levels.

The lowermost surface of the recess may be shaped to further improve the grip of the cured resin therein. For example, the lowermost surface 6 of the recess may be conical, although other shapes can be envisaged.

The grip of the cured resins may also be further improved by having all or part of the wall 7 of the recess roughened or provided with protrusions or other friction-improving means, as illustrated in FIG. 3 wherein a roughened wall 7a is shown.

FIG. 4 shows part of a surgical instrument in which a plurality of recesses 4 have been formed. It can be seen that the lowermost surfaces 6 are of a greater diameter than the diameter of the uppermost apertures 5. One of the recesses is illustrated with a coloured resin label 8 in place.

Although the above describes applying a resin label to a surgical instrument, this is intended as a non-limiting example of an application of the present invention. Other applications for the invention may be envisaged, for example, the provision of coloured labels on engineering equipment which is intended to be used in a high temperature environment.

1. A method of labelling an instrument comprising the steps of:
providing a recess in a surface of the instrument, the recess having a lowermost surface and an uppermost aperture, the lowermost surface having a larger surface area than the area of said uppermost aperture;
applying a coloured liquid resin into said recess;
heating the instrument in order to cure said resin, whereby a coloured resin label is formed in said recess.

2. A method as claimed in claim 1 wherein the walls of said recess taper inwardly from said lowermost surface to said uppermost aperture.

3. A method as claimed in claim 1 or claim 2 wherein said recess has a roughened or other friction-increasing wall.

4. A method as claimed in any of the preceding claims wherein said recess is of substantially circular cross-section.

5. A method as claimed in any of the preceding claims wherein said lowermost surface of the recess is generally conical.

6. A method as claimed in any of the preceding claims wherein said recess is provided with a parallel-walled section at the uppermost surface thereof.

7. A method as claimed in any of the preceding claims further comprising the step of preheating the instrument before applying the resin.

8. A method as claimed in any of the preceding claims wherein said resin is applied to the recess using metering apparatus.

9. A method as claimed in any of the preceding claims wherein the recess is filled with resin until a substantially concave meniscus is present at the uppermost aperture of the recess.

10. A method as claimed in any of the preceding claims wherein said resin is a two-part liquid resin which is mixed before placing it in the recess.

11. A method as claimed in claim 10 when dependent on claim 8 further comprising the step of mixing said resin in said metering apparatus.

12. A method as claimed in any of the preceding claims wherein said resin is an epoxy resin selected from the group comprising: Master Bond EP42HT-2, Resin Tech RT156.

13. A method as claimed in any of the preceding claims wherein said resin is cured for 24 hours at room temperature.

14. A method as claimed in any of claims 1-12 wherein said resin is cured for 30 minutes at 75° C.

15. A method as claimed in any of claims 1-12 wherein said resin is cured for 5 minutes at 100° C.

16. A method as claimed in any of claims 1-12 wherein said resin is cured for 24 hours at room temperature and then 2 hours at 75° C.

17. A method as claimed in any of the preceding claims wherein two or more recesses are provided on the instrument.

18. A method of labelling an instrument substantially as described herein with reference to any appropriate combination of the accompanying drawings.

19. A method as claimed in any of the preceding claims in which the instrument is a surgical instrument.

20. An instrument labelled using the method of any of the preceding claims.
